(19) United States
(12) Patent Application Publication
(10) Pub. No.: US 2007/0030403 A1
(43) Pub. Date: Feb. 8, 2007

(54) Reduced "chin" height projection TV

(75) Inventor: Gary L. Sextro, Frisco, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/161,498

(22) Filed: Aug. 5, 2005

(51) Int. Cl. H04N 5/64

(52) U.S. Cl. 348/789

(57) ABSTRACT

Described are projection televisions with substantially reduced chin height. In one embodiment, an optical projection engine may be mounted to one side of a TV screen, thereby facilitating a projection television with reduced chin height. In other embodiments, two or more optical projection engines may be mounted in a cabinet to various sides of a TV screen, thereby facilitating a projection television with reduced chin height, added brightness, resolution, and/or other performance enhancements.

### TECHNICAL FIELD

Disclosed embodiments relate to televisions, and more particularly to reduced “chin” height projection televisions.

### BACKGROUND

FIG. 1 illustrates a prior-art projection television 100 with an optical engine 106 situated at the bottom of a TV screen 102, and enclosed within a housing or a cabinet 104 typically made of plastic. Traditionally, the optical engine 106 is placed underneath the TV screen 102 because of its size and weight. An image 110 may then be projected onto the TV screen 102 from the optical engine 106 through various mirrors and lenses, including flat or curved fold mirrors (not shown). As a result of the need to accommodate the optical engine 106 and the various optical components (not shown), there exists a certain cabinet or “chin” height 108 of about 4 to 8 inches between the bottom of the TV screen 102 and the bottom of the cabinet 104. The cabinet or chin height 108 is also referred to as the portion chin 108 or the lower jaw 108 of the projection television 100.

### SUMMARY

Described are projection televisions with substantially reduced chin heights. In one embodiment, an optical projection engine may be mounted to one of the sides of a TV screen, thereby facilitating a projection television with reduced chin height. Additionally, two or more optical projection engines may also be mounted in a cabinet around the TV screen to provide a reduced chin height projection television. The extra optical projection engine(s) may add brightness, resolution, and/or other performance enhancements.

### BRIEF DESCRIPTION OF THE DRAWINGS

FIG. 1 illustrates a prior-art projection television;

FIG. 2 illustrates a projection television using a presently disclosed embodiment of two optical projection engines;

FIGS. 3A-3B illustrate vertical and horizontal stitching of an image, respectively;

FIG. 4 illustrates diagonal inter-stitching of an image;

FIG. 5 illustrates dithering of an image; and

FIGS. 6A-6C illustrate projection televisions with various optical projection engine embodiments.

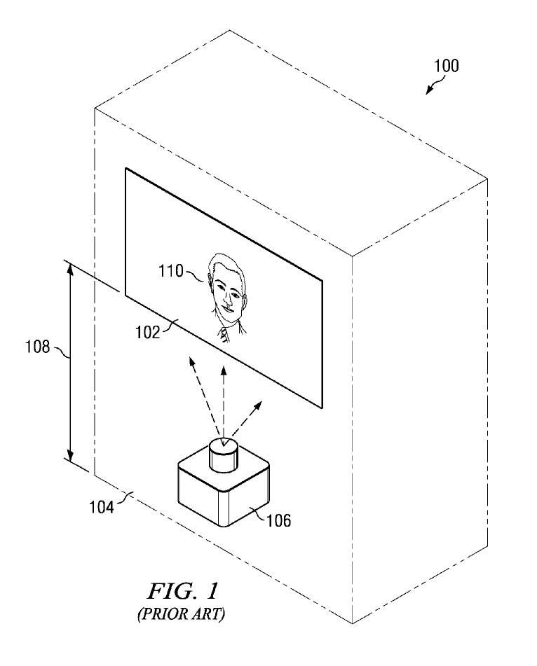

### DETAILED DESCRIPTION OF THE PREFERRED EMBODIMENTS

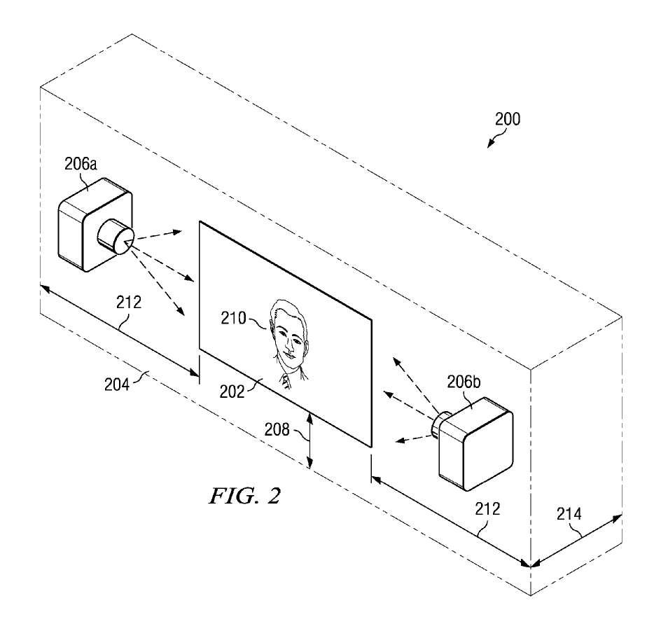

FIG. 2 shows a projection television 200 using the presently disclosed embodiments resulting in substantially reduced chin height 208 between the bottom of the TV screen 202 and the bottom of the TV cabinet 204. In particular, “substantially reduced” should be understood to be less than 3″, 2″, 1″, or less. As illustrated, two optical projection engines 206 may be situated on the sides of the TV screen 202, with one engine 206 on each side, thereby creating a projection television 200 with substantially reduced chin height 208. Since there is no longer an optical projection engine 106 underneath the TV screen 102, the chin height 208 can be reduced to 3″, 2″, 1″, or less. This can be accomplished because the modern optical projection engines 206 are smaller and lighter than traditional optical projection engines 106. Additionally, the extra width 212 created in the TV cabinet 204 by the addition of the two optical projection engines 206 may be used to house speakers or other audio elements (not shown).

The optical projection engines 206 may be refractive or reflective in nature with each optical projection engine 206 containing a light source such as a LED, a laser, or a xenon lamp, optical elements and lenses, a spatial light modulator (SLM) along with a digital micromirror device (DMD), and projection optics and lenses. The features and functions of SLMs and DMDs are further described in a commonly owned U.S. Pat. No. 6,643,069 entitled “SLM-based color projection display having multiple SLM's and multiple projection lenses,” Ser. No. 09/940,978, filed Aug. 28, 2001, which is incorporated herein by reference in its entirety for all purposes.

In addition, a projection television 200 with a thinner cabinet depth 214 may be created with two optical projection engines 206. This is because rather than having to project an entire screen of images from a single light projection engine 206, it is now possible to distribute the projection and the dedicated optical components (not shown) between the two sides of the projection television 200.

Furthermore, the use of two optical projection engines 206 may enable additional features to be implemented, including doubling the overall brightness of an image 210 on the TV screen 202 of the projection television 200. One optical projection engine 206a may generate an image 210 on the TV screen 202 and the other optical projection engine 206b may also generate the same image 210 on the TV screen 202. The result is an overlapping image 210 with twice the brightness or lumens on the TV screen 202 versus an image 110 generated by a single optical projection engine 106 in a traditional projection television 100.

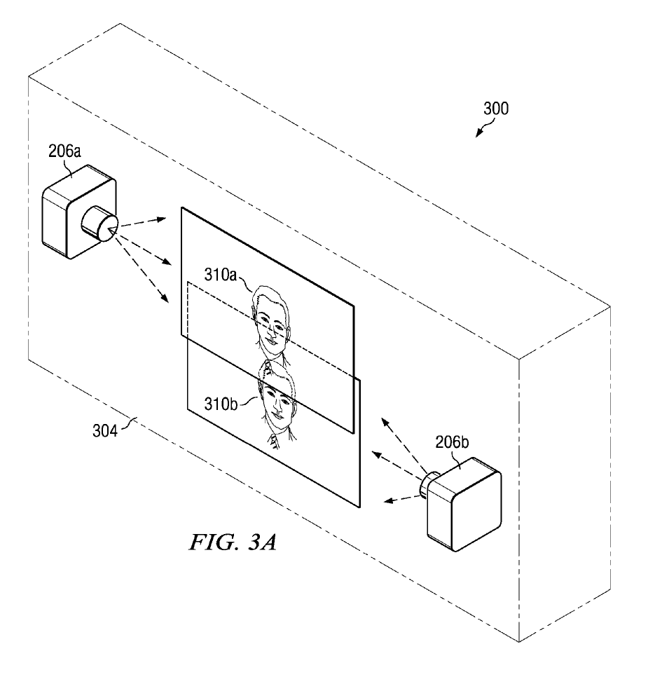

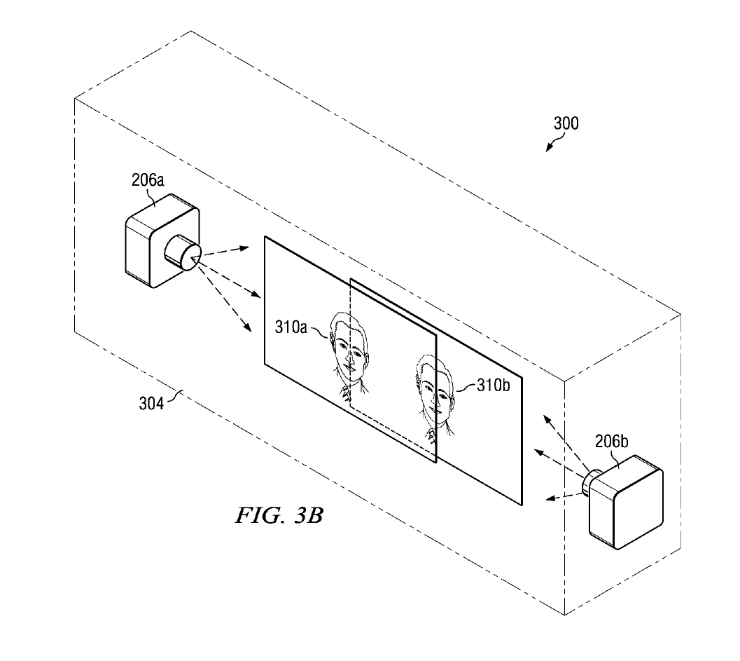

Additionally, the two optical projection engines 206 may also be combined to form projections of a composite image 210, thereby doubling its resolution. For example, assume a traditional projection television 100 has an optical projection engine 106 that can project an image 110 with extended graphics array (XGA) resolution of 1024×768 pixels. Since a projection television 200 with the presently disclosed embodiments has two optical projection engines 206, the composite image 210 will have twice the resolution by the same principle as previously discussed. The doubling of the resolution may be accomplished by stitching together two images 310a, 310b vertically and/or horizontally, as shown in FIGS. 3A-3B, respectively. As illustrated, the two images 310a, 310b may be similar images with some overlap. The overlap is where the images 310a, 310b are stitched together with resizing and stretching as necessary. Additionally, the two images 310a, 310b may be the same image with 100% overlap. When the two images 310a, 310b are stitched together, the result is a composite image 310 with twice the resolution.

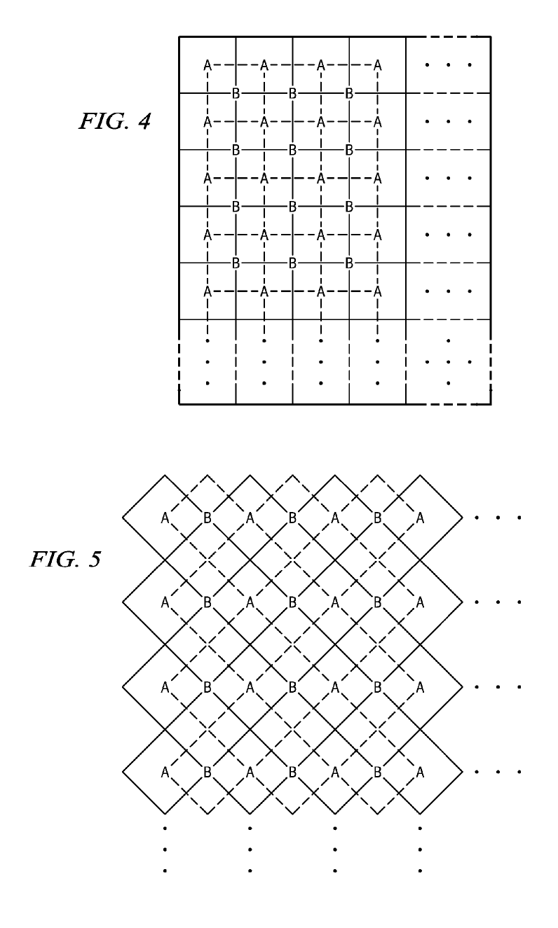

Additionally, the doubling of the resolution may be accomplished by inter-stitching two images 310a, 310b vertically and/or horizontally, such that the pixels from the two light engines 206a, 206b are overlapped, as shown in FIG. 4. The new image 310 may have twice the resolution by the same principle as previously discussed. As illustrated in FIG. 4, the “a” pixels are from one projector while the “b” pixels are from another projector. The “b” pixels are sitting on top of the “a” pixels at a diagonal. When the “b” pixels are inter-stitched or overlapped with the “a” pixels, the image resolution is doubled.

Furthermore, cheaper and lower-resolution optical projection engines 206 may be used to generate images 210 with comparable if not better resolution than an image 110 generated in a traditional projection television 100. From the example above, instead of doubling the resolution from XGA, the two optical projection engines 206 may be designed to provide only video graphics array (VGA) resolution of 640×480 pixels. By combining or stitching together the two optical projection engines 206 with VGA resolution, the generated image 210 will still have better resolution {2×(640×480 pixels)=1280×960 pixels} than an image 110 generated by a single optical projection engine 106 with XGA resolution. The cheaper and lower resolution optical projection engines 206 may also be smaller leading to projection televisions 200 with smaller cabinets 204 than a single high-resolution optical projection engine 106 that is larger and may require more chin height 108. Note also that the video formats are merely exemplary for forming an image with a compatible high-definition television (HDTV) pixel aspect ratio. The combined “VGA” resolution from the two optical projection light engines 206 would most likely require a different format than 640×480, depending on whether the optical projection light engines' 206 contributions are combined vertically and/or horizontally.

Additionally, the resolution may be doubled without an actuator or quadrupled with an actuator implementing smooth picture imaging techniques. Quadruple resolution may be achieved with two optical projection engines 206 with the left optical projection engine 206a moving or smoothing in the x-axis, and the right optical projection engine 206b interpolating pixels in the y-axis. Likewise, the left and right optical projection engines 206 are interchangeable as well as the x- and y-axes. As a result, there will be 4× the resolution due to dithering of the displayed image 210. The projected pixels may be rectangular, orthogonal, or diamond.

Additionally, color dithering can simulate a color value that cannot be displayed using a mixture of displayable colors. For example, mixing black and white to create gray. Dithering may be accomplished by oscillating in fixed pointing directions, such as in the x- or y-axes, or in various directions, orientations, and patterns. Specific embodiments of implementing dithering are further described in commonly assigned Ser. No. 11/051,373, entitled “Optical System and Method for Increasing Image Resolution and/or Dithering in Projection Applications,” filed Feb. 4, 2005, which is hereby incorporated herein by reference in its entirety for all purposes.

In particular, a pixel pattern such as shown in FIG. 5 with other pixel patterns may be achieved to accomplish doubled, quadrupled, or even higher resolutions according to the timing of the dithering, the swing of the relevant image projection, and the synchronization of those elements. As illustrated in the figure, the “a” diamond pixels are from one projector while the “b” diamond pixels are from another projector. The “b” diamond pixels are horizontally to the left and right of the “a” diamond pixels. When one set of diamond pixels dithers, the image resolution is doubled. When both sets of diamond pixels dither, the image resolution is quadrupled.

Additionally, having more than one optical projection engine 206 means being able to use different primary colors within the projection television 200. For example, the left optical projection engine 206a may operate with three primary colors, such as red, green, and blue, while the right optical projection engine 206b may operate with another three colors, such as cyan, magenta, and yellow. The two optical projection engines 206 may contain colors that may or may not complement each other. The two optical projection engines 206 may also contain more or fewer than three colors.

Three-dimensional (3D) functionalities may also be generated with the two optical projection engines 206 in the projection television 200. The left optical projection engine 206a may operate an even field while the right optical projection engine 206b may operate an odd field. Also, which optical projection engine 206 will project which field may be arbitrary.

Another benefit of the presently disclosed embodiment is that there will be a light source redundancy. Since there are now two optical projection engines 206, if the left optical projection engine 206a dies, then the right optical projection engine 206b can still keep the projection television 200 functional, and vice versa. Therefore, a lamp or light source redundancy exists in having two optical projection engines 206 whereby each optical projection engine 206 serves as a backup to the other.

In another embodiment, instead of two optical projection engines 206, only one optical engine 206a is located within the projection television 200. The optical projection engine 206a may be positioned to either side of the TV screen 202. The optical projection engine 206a may also be positioned inside the TV cabinet 204 on top of the TV screen 202. Placing the optical engine 206a to only one side of the TV screen 202 will retain the substantially reduced or substantially zero chin height 208, since there is no longer an optical projection engine 106 underneath the TV screen 102. While many of the additionally benefits previously discussed with dual optical projection engines 206 would not be available to a single optical projection engine 206, the reduced chin height 208 may still be accomplished by this approach and without the added expense of an extra optical projection light engine 206.

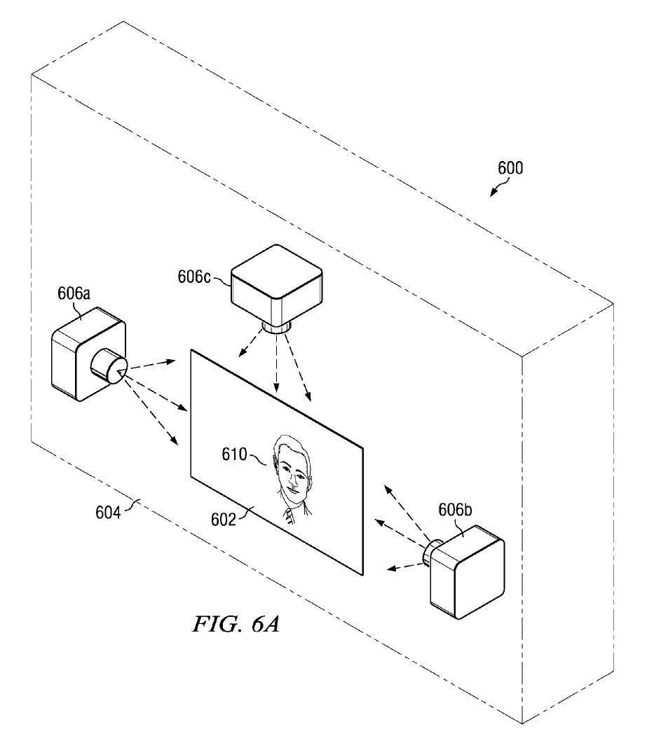

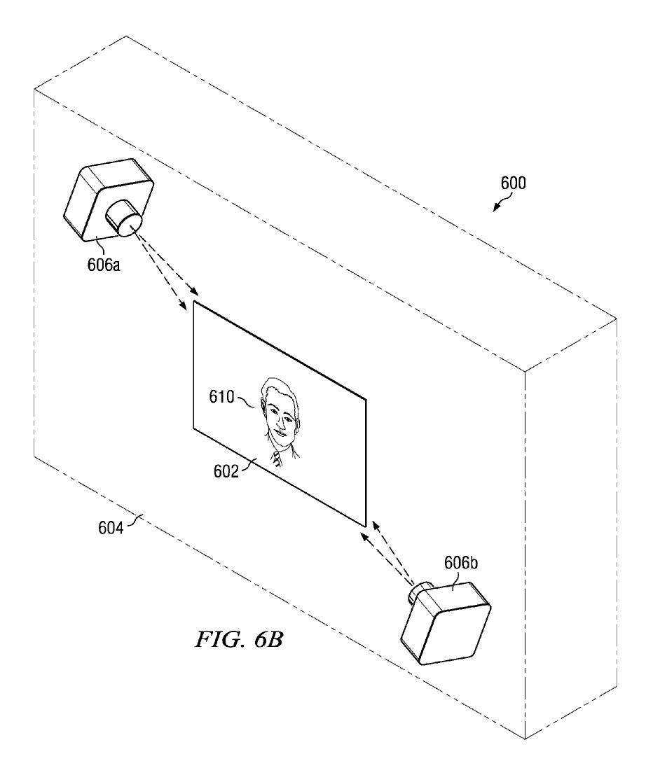

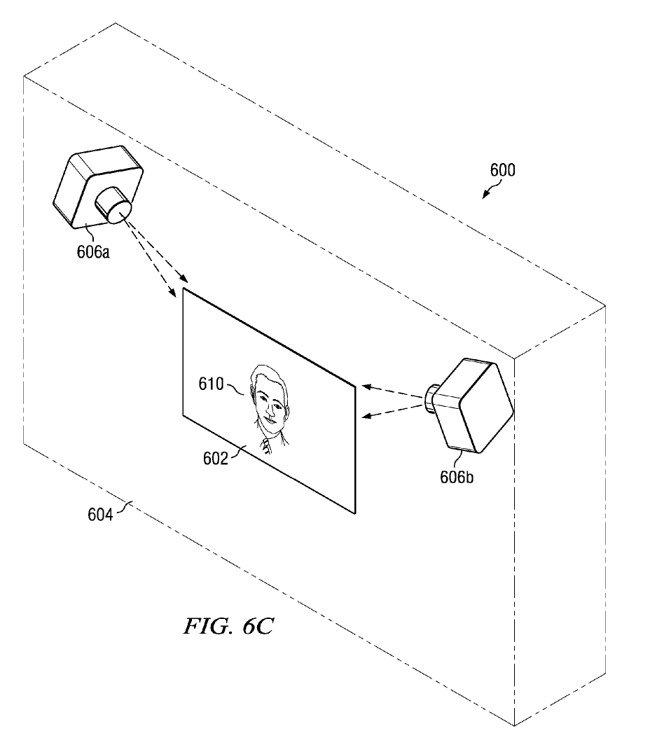

It will be appreciated by those of ordinary skill in the art that the invention can be embodied in other specific forms without departing from the spirit or essential character thereof. For example, additional optical engines 206 may be added to the projection television 200, such as a third optical engine 206c located at the top of the TV screen 202 as illustrated in FIG. 6A. Also, the optical engines 206 may be angled relative to the TV screen 202 as shown in FIG. 6B. Additionally, the two optical engines 206 may be situated at the upper left and right-hand corners of the TV screen 202 as seen in FIG. 6C. Furthermore, there may also be other upgradeable designs that have not been anticipated by the optical projection engines 206, such as using multiple optical projection engines 206 with lower cost and/or size. The presently disclosed embodiments are therefore considered in all respects to be illustrative and not restrictive. The scope of the invention is indicated by the appended claims rather than the foregoing description, and all changes that come within the meaning and ranges of equivalents thereof are intended to be embraced therein.

Additionally, the section headings herein are provided for consistency with the suggestions under 37 C.F.R. § 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A projection television, comprising:
a screen;
two optical projection engines operable to project two images on the screen, the first optical projection engine situated to a first side of the screen and the second optical projection engine situated to a second side of the screen; and
a cabinet for housing the screen and the optical projection engines, the screen being positioned substantially at the bottom of the cabinet.

2. A television according to claim 1, wherein the bottom of the screen is within 2″ of the bottom of the cabinet.

3. A television according to claim 1, wherein the television is a rear projection television.

4. A television according to claim 1, wherein the first and second sides of the screen are the same side.

5. A television according to claim 1, wherein the two projected images are the same.

6. A television according to claim 1, wherein the two projected images together form a composite image.

7. A television according to claim 6, wherein the composite image is stitched or inter-stitched for double resolution.

8. A television according to claim 6, wherein the composite image is dithered for quadruple resolution.

9. A projection television, comprising:
a screen;
an optical projection engine operable to project an image on the screen, the optical projection engine situated to a first side of the screen; and
a cabinet for housing the screen and the optical projection engine, the screen being positioned substantially at the bottom of the cabinet.

10. A television according to claim 9, wherein the bottom of the screen is within 2″ of the bottom of the cabinet.

11. A television according to claim 9, wherein the television is a rear projection television.

12. A projection television, comprising:
a screen;
at least three optical projection engines, each operable to project an image on the screen, the first optical projection engine situated to a first side of the screen, the second optical projection engine situated to a second side of the screen, and the third optical projection engine situated to a third side of the screen; and
a cabinet for housing the screen and the optical projection engines, the screen being positioned substantially at the bottom of the cabinet.

13. A television according to claim 12, wherein the bottom of the screen is within 2″ of the bottom of the cabinet.

14. A television according to claim 12, wherein the television is a rear projection television.

15. A television according to claim 12, wherein at least two of the three sides of the screen are the same side.

16. A television according to claim 12, wherein the three projected images are the same.

17. A television according to claim 12, wherein the three projected images together form a composite image.

18. A television according to claim 17, wherein the composite image is stitched or inter-stitched for triple resolution.

19. A television according to claim 17, wherein the composite image is dithered for octuple resolution.

20. A television according to claim 17, wherein the composite image has triple brightness.
